(19) United States
(12) Patent Application Publication
(10) Pub. No.: US 2007/0153909 A1
(43) Pub. Date: Jul. 5, 2007

(54) APPARATUS FOR IMAGE ENCODING AND METHOD THEREOF

(75) Inventors: YUN-CHING LEE, TAOYUAN COUNTY (TW); PAI-CHU HSIEH, TAIPEI CITY (TW); HSIN-TZU LIU, TAIPEI COUNTY (TW)

Correspondence Address: J C PATENTS, INC., 4 VENTURE, SUITE 250, IRVINE, CA, 92618, US

(73) Assignee: SUNPLUS TECHNOLOGY CO., LTD., HSINCHU (TW)

(21) Appl. No.: 11/617,335

(22) Filed: Dec. 28, 2006

(30) Foreign Application Priority Data
Jan. 4, 2006 (TW) 95100311

(51) Int. Cl. H04N 11/04; H04N 7/12

(52) U.S. Cl. 375/240.24; 375/240.26

(57) ABSTRACT

A method for image encoding is provided, which are capable of encoding video images using a lower memory bandwidth. The method includes the following steps. First, a reference window of a reference frame is read and the position of the reference window is called a first position. Secondly, macroblocks of at least two of the estimated frames are read, and the position of macroblocks is called a second position, wherein the second position corresponds to the first position. Next, block matching is executed between macroblocks and the reference window. Finally, reading position of the first position and the second position are changed, and then the above steps are repeated until block matching of all macroblocks within at least two of the frames is finished in the estimated frames.

### CROSS-REFERENCE TO RELATED APPLICATION

This application claims the priority benefit of Taiwan application serial no. 95100311, filed Jan. 4, 2006. All disclosure of the Taiwan application is incorporated herein by reference.

### BACKGROUND OF THE INVENTION

1. Field of Invention

The present invention relates to a method for image encoding, and more particularly, to an apparatus for encoding a video image with a plurality of reference frames and a plurality of frames to be estimated and the method thereof.

2. Description of Related Art

Digital video images are usually provided with an excessively large amount of data, and during executing digital image encoding or image compression, large data transmission bandwidth is required in addition to the large memory capacity and the high digital calculating speed. Therefore, conventionally, the higher the quality of frames to be encoded or compressed, the higher memory bandwidth is required, thus indirectly affecting other data transmission speed.

As for motion picture experts group (MPEG), three types of frames are normally used for the video image encoding or the image compression: I frame (intra-coding frame), P frame (prediction frame), and B frame (bi-directional frame). The block matching algorithm is used to respectively match I frame and P frame to achieve the effect of compressing B frame and P frame, wherein P frame includes P₀-P₂ frames.

FIG. 1A is a schematic view of the conventional MPEG image encoding method. To increase the compression rate and also consider the image quality, the motion estimation in the conventional image encoding approaches includes a bi-direction prediction encoded frame, i.e., B frame bi-direction reference: a forward and a backward searching approach. As shown in FIG. 1A, B₂ frame is generated by carrying out the forward search with I frame, and carrying out the backward search with P₀ frame. B₃ frame is similarly generated by carrying out the forward search with I frame, and carrying out the backward search with P₀ frame. The image encoding procedure is that: the block matching between B₂ frame and I frame, and between B₂ frame and P₀ frame are executed, and then the block matching between B₃ frame and I frame, and between B₃ frame and P₀ frame are carried out. In other words, the block matching is sequentially executed to each macroblock in the frame, and then the matching and encoding of the next macroblock is carried out.

FIG. 1B is a conventional block matching approach. With the conventional approach, to match the macroblocks (120, 130) at the position 0, the reference window 101 of I frame corresponding to the position 0, as well as the reference window 102 of P₀ frame corresponding to the position 0 should be read twice. Therefore, when executing block matching between B₂ frame and B₃ frame, I frame and P₀ frame will be read twice, thus resulting in a waste of memory bandwidth. Especially, when encoding high-definition digital TV or a high-definition digital video disc, the bandwidth required for reading the frame data of I frame, P frame, and B frame will be increased accordingly.

Taking DVD with a resolution of 720×480 as an example, if the reference window is provided with a 48×48 full search approach, the bandwidth required by all macroblocks in the frame to be estimated is 720×480=345600 pixel data; the bandwidth required by the reference window is 48×720×(480/16-48/16+1)=967680 pixel data; and the bandwidth required for the motion estimation of B₂ frame and B₃ frame is 2×2(345600+967680)=5253120 pixel data. Since in the conventional block matching approach, the blocking matching between B₂ frame and I and P₀ frames is executed first, such that the data of both the macroblock in B₂ frame and the reference window is required to be read twice, because the reference window is I frame plus P₀ frame, and then the block matching between B₃ frame and I and P₀ frames is executed, so that the whole bandwidth required should be doubled. Under the circumstances of limited memory bandwidth, the repeated reading of a large amount of data will burden the system memory bandwidth, thus affecting the efficacy of other system operations.

### SUMMARY OF THE INVENTION

An object of the present invention is to provide an image encoding method suitable for encoding a video image with a plurality of reference frames and a plurality of frames to be estimated. The encoding flow is changed, and the reference window that has been read is repeatedly used to carry out block matching with the macroblocks in different frames to be estimated. The reference window is less frequently read, and the motion estimation calculation of the image encoding can be achieved with lower memory bandwidth.

Another object of the present invention is to provide an image encoding method suitable for encoding a video image with a plurality of reference frames and a plurality of frames to be estimated. By changing the data processing flow of the motion estimation calculation for the motion estimator, the reference window is less. frequently read, thereby saving the memory bandwidth.

To achieve the above and other objects, the present invention provides an image encoding method suitable for encoding a video image. The video image has a plurality of reference frames and a plurality of frames to be estimated. The aforementioned image encoding method includes the following steps. First, the reference window is read from a plurality of reference frames and a plurality of macroblocks is read from at least two frames to be estimated. The positions of the reference window and the macroblocks are the first position and the second position, respectively. The second position corresponds to the first position.

The plurality of macroblocks read in the step is respectively located at the same position, i.e., the second position in different frames to be estimated. The motion estimation encoding calculation is required to be carried out between the macroblocks at this position and the reference window at the corresponding position. The position where the reference window located is the first position. The motion estimation calculation is required to be carried out between the macroblocks at different positions and the reference window at the specific position, such that there is a corresponding relation between the first position and the second position.

Subsequently, the block matching between the macroblocks and the reference window is executed. This step is the motion estimation of the image encoding. For example, the full-search block matching algorithm is used for executing block matching between the macroblocks and the reference window with corresponding positions. The image block that is most similar to the macroblocks is searched in the reference window to obtain the most preferred motion vector; thereby, the most optimized reference macroblock can be found in the reference window according to the: most preferred motion vector.

Then, the first position and the second position are changed, and the steps described above are repeated until block matching of all macroblocks on at least two of the frames to be estimated has been finished. As the frame includes more than one macroblock, the first position and the second position can be changed by moving the positions of the macroblocks and the corresponding reference window. Block matching between the macroblocks at different positions and the reference window is executed respectively until block matching between at least two of the frames to be estimated and the reference window has been finished. Therefore, the reference window that has been read each time can be used for the blocking matching of more than two macroblocks; The repeated reading of the reference window can be avoided, and the memory bandwidth required during the data transmission is lowered.

To achieve the aforementioned and other objects, the present invention provides an image encoding apparatus suitable for encoding a video image. The video image has a plurality of reference frames and a plurality of frames to be estimated. The image encoding apparatus includes a memory, a motion estimator, and an image encoding unit. The memory has a plurality of memory buffers and frame buffers used for respectively storing the data of a reference window in one of the reference frames and the data of a plurality of macroblocks of at least two frames to be estimated read by the image encoding apparatus. The position of the reference window is the first position, the position of the macroblocks is the second position, and the second position corresponds to the first position. The memory includes a plurality of buffer blocks, which act as the memory buffer and the frame buffer respectively. The data included in the frames to be estimated and the reference frame data are respectively stored into the memory buffer and the frame buffer.

The motion estimator described above is coupled to the memory to execute block matching between macroblocks and the reference window. When the motion estimator has finished block matching between macroblocks of at least two frames and the reference window, the first and second positions are changed, and the block matching is repeated by the motion estimator until the motion estimator has finished block matching of all macroblocks of at least two frames to be estimated. The reference window read each time can be used for the block matching of a plurality of frames to be estimated. The reference window data is less frequently read, thus saving the memory bandwidth. The image encoding unit is coupled to the motion estimator and the memory to execute tasks such as motion compensation, discrete cosine transform (DCT), quantization (Q), the frame rebuilding for the current process, etc, so as to encode the image frame. According to a preferred embodiment of the present invention, the reference frame described above includes an I frame and a P frame. The frames to be estimated may include a plurality of B frames and P frames.

In another aspect, the present invention further provides an image encoding method, including a forward search and a backward search. The image encoding method is suitable for encoding a video image with a plurality of reference frames and a plurality of frames to be estimated. The image encoding method includes the following steps. First, one of the reference windows and at least two frames to be estimated are read. Then, if one of the read reference frames is located before the read frames to be estimated, the forward search is carried out to achieve the block matching between at least two frames to be estimated that have been read and the reference frames. If the read reference frame is located after the read frames to be estimated, a backward search is carried out to achieve block matching between at least two frames to be estimated that have been read and the reference frame. The image encoding method of forward search and backward search have been described in the present invention in details and it can be easily derived by those skilled in the art from the disclosure of the present invention, and thus will not be described any more herein.

In the present invention, the reference window read each time can be used to match with the corresponding macroblocks in different frames to be estimated, such that the data processing flow of the motion estimation calculation for the motion estimator is changed; the reference window can be less frequently read; and the motion estimation calculation can be achieved by the image encoding apparatus with a relative low memory bandwidth. Taking a DVD with a resolution of 720×480 as an example, if the reference window employs 48×48 full search approach, the bandwidth required by all macroblocks in the frame to be estimated is 720×480=345600 pixel data; the bandwidth required by the reference window is 48×720×(480/16-48/16+1)=967680 pixel data; and with the approach of the present invention, the bandwidth required by the motion estimation of B₂ frame and B₃ frame is 2×(345600×2+967680)=3317760 pixel data, because the data for reading the reference window twice is eliminated, which can save about 36.8% memory bandwidth compared with the 5253120 pixel data of bandwidth required in the conventional estimation approach. The larger the reference window data is, the more bandwidth is saved, and the more significant the efficacy.

In order to make the aforementioned and other objects, features and advantages of the present invention comprehensible, a preferred embodiment accompanied with figures is described in detail below.

### BRIEF DESCRIPTION OF THE DRAWINGS

FIG. 1A is a schematic view of a conventional MPEG image encoding method.

FIG. 1B is a conventional block matching approach.

FIG. 2 is a schematic view of the image encoding method with the forward search and backward search according to an embodiment of the present invention.

FIG. 3 is a view of the block matching approach according to an embodiment of the present invention.

FIG. 4 is a flow chart of the image encoding method according to another embodiment of the present invention.

FIG. 5 is a view of the image encoding apparatus according to another embodiment of the present invention.

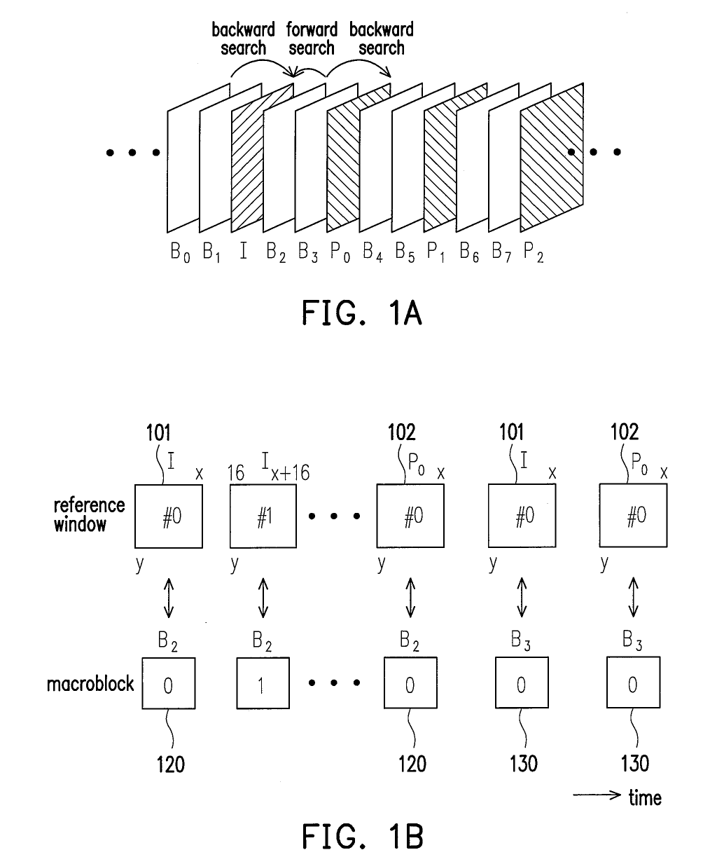

### DESCRIPTION OF EMBODIMENTS

The motion estimation calculation during image encoding usually requires a lot of memory bandwidth resources. As the image data needs to be read continuously for block matching and encoding, the reference frames are repeatedly used to match with different frames to be estimated in the present invention, thereby saving the memory bandwidth.

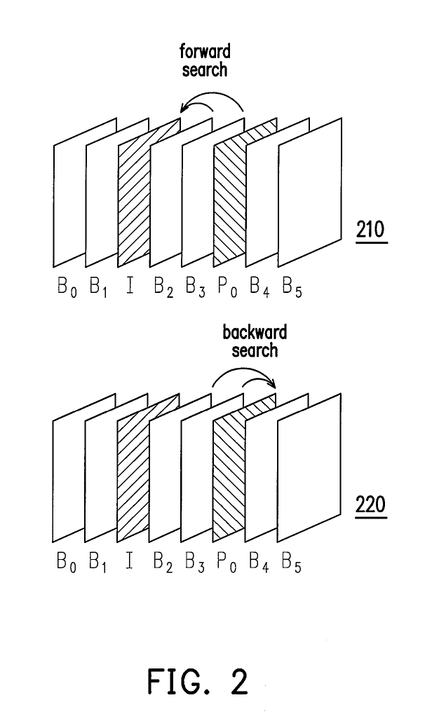

FIG. 2 is a schematic view of an image encoding method with the forward search and backward search according to an embodiment of the present invention. As shown in FIG. 2, B₀-B₅ frames are B frames, i.e., frames to be estimated. I and P₀ frames are belonged to I frames and P frames respectively, and both can be reference frames. When the block matching between frames to be estimated and the reference window is required to be executed, if the read reference frame is located before the read frames to be estimated, the forward search is carried out, such as the forward-search matching approach 210, to achieve the block matching between at least two (B₂ frame, B₃ frame) of the frames to be estimated that have been read and the reference frame (I frame); otherwise, if the read reference frame is located after the read frames to be estimated, a backward search, such as the backward-search matching approach 220, is carried out to achieve block matching between at least two (B₂ frame, B₃ frame) of the read frames to be estimated and the reference frame (P₀ frame).

When the frames to be estimated (B₂ frame, B₃ frame) are required to carry out forward-search block matching with I frame, the matching between I frame and the corresponding frames to be estimated (B₂ frame, B₃ frame) is carried out and followed by the next encoding procedure as shown in the forward-search matching approach 210. When the frames to be estimated (B₂ frame, B₃ frame) are required to carry out backward-search block matching with P₀ frame, the back search block matching between P₀ frame and the corresponding frames to be estimated (B₂ frame, B₃ frame) is carried out, then followed by the next encoding procedure as shown in the backward-search matching approach 220. Moreover, in another embodiment of the present invention, P₀ frame also can act as a frame to be estimated, which can be estimated through the way similar to the block matching of the frames to be estimated (B₂ frame, B₃ frame) in the present embodiment, which can be easily appreciated by those skilled in the art from the disclosure of the present invention, and thus it will not be described any more herein. In the present embodiment, B frame is merely taken as an example to be illustrated below.

In another embodiment, the forward-search and the backward-search approaches also can be achieved by fast-search block matching algorithm. Although the full-search block matching algorithm is taken as an example in the present embodiment, it is easily for those skilled in the art to appreciate that the block matching approach of the present invention is not limited to the full-search block matching algorithm or the fast-search block matching algorithm as described above.

According to the matching approach described above, I frame and P₀ frame only need to be read once, and then both can be used to carry out the block matching with different frames to be estimated (B₂ frame, B₃ frame), thus reducing the data transmission and significantly saving the memory bandwidth. Although only the frames to be estimated (B₂ frame, B₃ frame) are taken as an example for illustration in the present embodiment, the block matching approach of the present invention is applicable for block matching between a plurality of frames to be estimated and a plurality of reference frames. Since those skilled in the art can easily appreciate it from the disclosure of the present invention, no further detailed description will be provided herein.

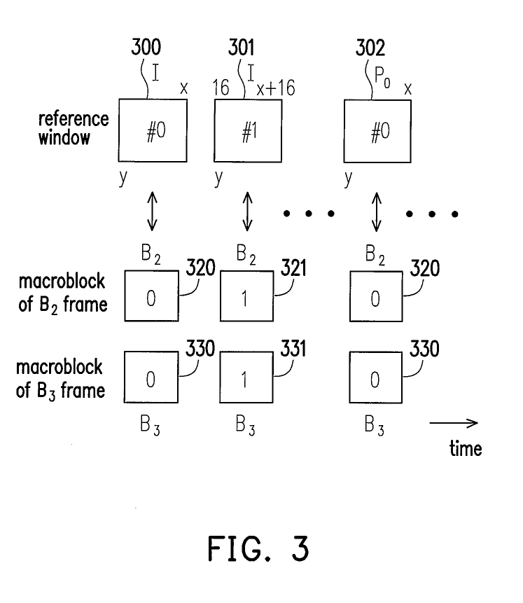

Next, block matching between the frames to be estimated (B₂ frame, B₃ frame) and the reference frames (I frame, P₀ frame) is further described. FIG. 3 is a view of the block matching approach according to the embodiment of FIG. 2 of the present invention. The macroblock 320 is a macroblock at the position 0 in B₂ frame. The macroblock 330 is a macroblock at the position 0 in B₃ frame. The reference window 300 is a reference window in I frame corresponding to the position 0. Similarly, the macroblock 321 and the macroblock 331 are the ones at the position 1 in B₂ frame and the B₃ frame, respectively. The reference window 302 is the one in P₀ frame corresponding to the position 0.

During image encoding, if block matching at the position 0 in the frames to be estimated is to be executed first the reference window 300 will be used to carry out block matching with the macroblock 320 and the macroblock 330 respectively. Then, block matching at the position 1 in the frames to be estimated is executed, and the corresponding reference window 301 is used to carry out the block matching with the macroblock 321 and the macroblock 331, respectively. Similarly, the positions of macroblocks are changed sequentially, and the corresponding reference window is repeatedly used to match with the macroblocks on the frames to be estimated (B₂ frame, B₃ frame) respectively until all such macroblocks that need to be matched have been matched. The matching process described above is the forward-search matching described in FIG. 2. In the matching process, the reference window in I frame at each corresponding position is only required to be read once, and then the block matching of the frames to be estimated (B₂ frame, B₃ frame) can be achieved.

Then, backward-search matching is executed, that is, block matching between the frames to be estimated (B₂ frame, B₃ frame) and P₀ frame. Just like the matching approach described above, block matching between the macroblocks at the position 0 and the reference window at the corresponding position is carried out through the same way as that of the aforementioned forward-search approach except I frame being replaced by P₀ frame. The positions of macroblocks are changed sequentially, and block matching between the macroblocks and the reference window at the corresponding position in P₀ frame is carried out, for example, the reference window 302 of P₀ frame corresponding to the position 0 is block matched with the macroblock 320 at the position 0 in B₂ frame and the macroblock 330 at the position 0 in B₃ frame respectively until all macroblocks on the frames to be estimated, such as B₂ frame and B₃ frame that need to be matched have been block matched with the reference window in P₀ frame. Similarly, the same data of the reference window is used for block matching with a plurality of macroblocks respectively, so that the repeated reading of the reference window can be avoided. When it is used in the block matching between a plurality of reference frames and a plurality of frames to be estimated the same effect of saving bandwidth also can be achieved. The larger the data of the reference window is, the more significant the bandwidth saving effect is. Although the frames to be estimated (B₂ frame, B₃ frame) and the reference frame (I frame, P₀ frame) are taken as an example for illustration in the present embodiment, the present invention is suitable for the block matching between a plurality of frames to be estimated and a plurality of reference frames. Since those skilled in the art can easily appreciate it from the disclosure of the present invention, no further detailed description will be provided herein.

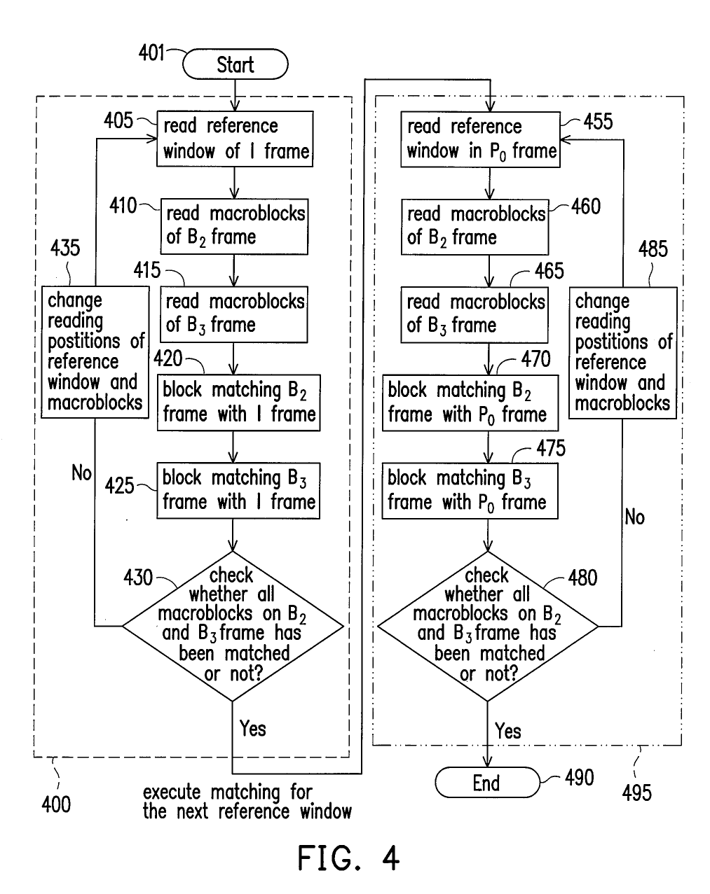

FIG. 4 is a flow chart of an image encoding method according to another embodiment of the present invention. In this embodiment, there are two frames to be estimated (B₂ frame, B₃ frame) and two reference windows (I frame, P₀ frame), which are briefly referred as B₂ frame, B₃ frame, I frame, and P₀ frame. The flow of the present invention can be divided into two parts: the block matching flow 400 of I frame and the block matching flow 4950 of P frame. First, the block matching flow 400 of I frame is illustrated, which begins with step 401. In step 405, the reference window of I frame is read, and the position of the reference window is called a first position. Then, the macroblock of B₂ frame is read in step 410, and the position of the macroblock is called a second position. The macroblock of B₃ frame is read in step 415, and said macroblock is also located at the second position in B₃ frame. The first position corresponds to the second position, which indicates that reference windows to be matched with macroblocks at different positions have a corresponding position relationship. Step 405 to step 415 constitute the data reading process. In different embodiments, the sequence of the steps can be varied as desired, which will not affect the efficacy of the method of the present invention.

In the subsequent step 420, the macroblock of B₂ frame read in step 410 is block matched with the reference window at the corresponding position in I frame, so as to obtain a most preferred motion vector and reference macroblock. In step 425, the macroblock of B₃ frame read in step 415 is block matched with the reference window at the corresponding position in I frame. In step 420, the block matching approach includes a fill-search block matching algorithm. In another embodiment, in steps 420 and 425, the block matching can be achieved through the fast-search block matching algorithm. Step 420 to step 425 are the block matching process, and no specific order between both steps is required. In different embodiments, the order of both steps can be varied, which will not affect the efficacy of the method of the present invention.

Next, step 430 is processed, wherein all macroblocks on the B₂ and B₃ frames are checked for whether they have been matched or not. If there are still macroblocks at different positions that have not been matched, in step 435, the reading positions of the reference window and the macroblock, the first position and the second position, are changed. After that, step 405 to step 430 are repeated until all macroblocks on the B₂ and B₃ frames that need to be matched have been matched with reference windows of I frame. When the matching has been finished, the block matching flow 495 of P frame begins. In the same way, in step 470 and step 475 of the present embodiment, the block matching approach includes a full-search block matching algorithm. In steps 470 and 475 of another embodiment, the block matching approach includes a fast-search algorithm.

The main difference between the block matching flow 495 of P frame and the block matching flow 400 of I frame lies in that the read and matched reference window is belonged to P₀ frame. Then, the reference window of P₀ frame is read in step 455. Macroblocks of B₂ frame and B₃ frame are read respectively in steps 460 and 465, wherein the position of macroblocks is called a second position; the position of the reference window is called a first position; and the second position corresponds to the first position. And then the block matching between B₂ frame and P₀ frame and that between B₃ frame and P₀ frame are executed by the full-search approach respectively in steps 470 and 475. Step 480 is used to check whether all macroblocks on the B₂ and B₃ frames have been matched or not. If not, the reading positions, the first and second positions of the reference window and the macroblock, are changed in step 485. After that, all steps in the block matching flow 495 of P frame are repeated until all macroblocks on the B₂ and B₃ frames that need to be matched have been matched. Once matching has been finished, the flow chart ends.

In the present embodiment, although only the frames to be estimated (B₂ frame, B₃ frame) and reference windows (I frame, P₀ frame) are taken as examples for illustration in the flow chart described above, the present invention is suitable for block matching between a plurality of frames to be estimated and a plurality of reference windows. Since it can be easily appreciated by those with ordinary skills in the art from the disclosure of the present invention, no further detailed description will be provided herein.

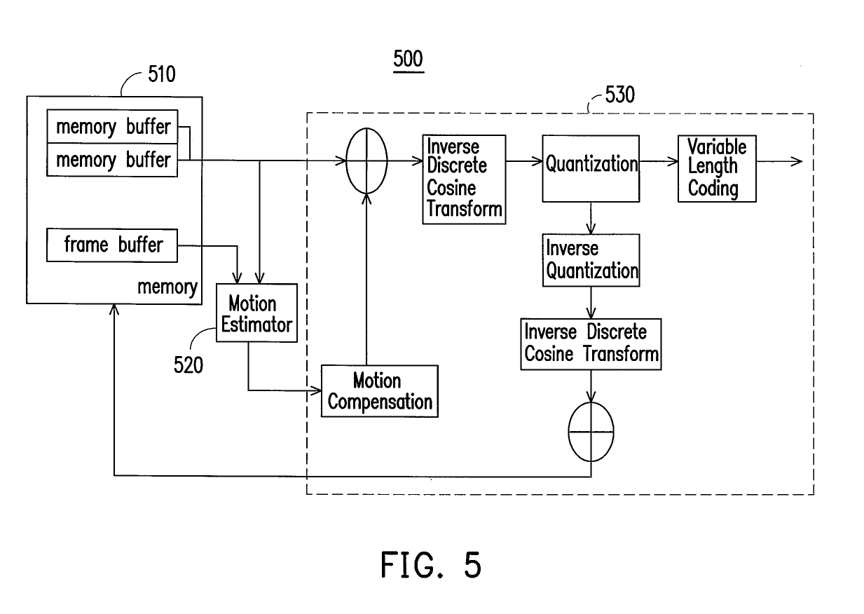

FIG. 5 is the view of an image encoding apparatus according to another embodiment of the present invention. As shown in FIG. 5, the image encoding apparatus 500 includes a memory 510, a motion estimator 520, and an image encoding unit 530. The memory 510 can be an external or internal memory with a frame buffer and a plurality of memory buffers used for respectively storing the data of the reference window in one of the reference frames and the data of a plurality of macroblocks of at least two of the frames to be estimated that have been read by the image encoding apparatus 500. The position of the reference window is called a first position; and the position of macroblocks is called a second position, wherein the second position corresponds to the first position.

The motion estimator 520 is coupled to the memory 510 and the image encoding unit 530 for executing block matching between macroblocks and a plurality of reference windows of the frames to be estimated, which are stored in the memory 510. Each time the image encoding apparatus 500 reads one reference window data, the motion estimator 520 uses the reference data to execute block matching with a plurality of macroblocks of at least two frames. When the motion estimator 520 has finished block matching between a plurality of macroblocks at the second position in different frames to be estimated and the reference window at the first position in the reference frame, the image encoding apparatus 500 changes the first position and the second position, and executes block matching by the motion estimator until the motion estimator has finished block matching between all macroblocks of at least two of the frames to be estimated and reference windows at the corresponding positions. The block matching described above can produce a corresponding motion vector. The aforementioned reference frames include a I frame and a P frame. Frames to be estimated include a B frame and a P frame. The approach used by the motion estimator 520 for executing block matching between macroblocks and reference windows includes a fall-search block matching algorithm. In another embodiment, the approach for executing the block matching between macroblocks and the reference windows includes a fast-search block matching algorithm.

The image encoding unit 530 is coupled to the memory 510 and the motion estimator 520 respectively to execute the image encoding, wherein the function blocks, such as discrete cosine transform (DCT), quantization (Q), inverse quantization (INVQ), inverse discrete cosine transform (IDCT), motion compensation, and variable length coding (VLC) are included. The image encoding unit 530 calculates a motion vector difference according to the motion vector generated by the block-matching result between macroblocks and reference windows. Based upon the aforementioned motion vector difference, the image editor 530 can carry out calculations, such as motion compensation, inverse discrete cosine transform, quantization, etc, to macroblocks so as to achieve the function of image encoding.

According to the embodiment described above, the reference window is less frequently read in the present invention, so that the reference window that has been read each time can be used to carry out the motion estimation calculation with macroblocks of the different frames to be estimated. The data process flow when the image encoding apparatus carries out the motion estimation calculation is changed, and the reference window is less frequently reduced, and the memory bandwidth required for image encoding is also lowered.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An image encoding method suitable for encoding a video image with a plurality of reference frames and a plurality of estimated frames, comprising:
reading a reference window from one of the reference frames, wherein a first position is the position of reference window;
reading a plurality of macroblocks of at least two of the estimated frames, wherein a second position is the position of macroblocks, and the second position corresponds to the first position;
executing block matching between the macroblocks and the reference window; and
changing reading positions of the first position and the second position, and repeating the above steps until the block matching for all the macroblocks in at least two of the estimated frames has been finished.

2. The image encoding method as claimed in claim 1, wherein the reference frames comprise a plurality of I frames and a plurality of P frames.

3. The image encoding method as claimed in claim 1, wherein the reference frames comprise a plurality of P frames.

4. The image encoding method as claimed in claim 1, wherein the estimated frames comprise a plurality of B frames.

5. The image encoding method as claimed in claim 1, wherein the estimated frames comprise a plurality of B frames and a plurality of P frames.

6. The image encoding method as claimed in claim 1, wherein the blocking matching between macroblocks and the reference window uses a full-search block matching algorithm.

7. The image encoding method as claimed in claim 1, wherein the blocking matching between macroblocks and the reference window uses a fast-search block matching algorithm.

8. An image encoding apparatus suitable for encoding a video image with a plurality of reference frames and a plurality of estimated frames, comprising:
a memory, having a plurality of memory blocks for respectively storing the data relating to a reference window in one of the reference frames and a plurality of macroblocks for at least two of the estimated frames that have been read by the image encoding apparatus, wherein a first position is the position of reference window, a second position is the position of macroblocks, and the second position corresponds to the first position;
a motion estimator, coupled to the memory, for executing block matching between the macroblocks and the reference window; and
an image encoding unit, coupled to the motion estimator and the memory, for image encoding;
wherein when the motion estimator has finished the block matching between the macroblocks and the reference window, reading positions of the first position and the second position are changed, the block matching is repeated until the motion estimator finishes the block matching between all the macroblocks of at least two of the frames and the reference window.

9. The image encoding apparatus as claimed in claim 8, further comprising a plurality of memory buffers and at least one frame buffer formed according to the memory blocks for respectively storing the data relating to the reference window in one of the reference frames and the macroblocks for at least two of the estimated frames that have been read by the image encoding apparatus.

10. The image encoding apparatus as claimed in claim 8, wherein the reference frames comprise a plurality of I frames and a plurality of P frames.

11. The image encoding apparatus as claimed in claim 8, wherein the reference frames comprise a plurality of P frames.

12. The image encoding apparatus as claimed in claim 8, wherein the estimated frames comprise a plurality of B frames.

13. The image encoding apparatus as claimed in claim 8, wherein the estimated frames comprise a plurality of B frames and a plurality of P frames.

14. The image encoding apparatus as claimed in claim 8, wherein the block matching between the macroblocks and the reference window uses a full-search block matching algorithm.

15. The image encoding apparatus as claimed in claim 8, wherein the block matching between the macroblocks and the reference window uses a fast-search block matching algorithm.

16. The image encoding apparatus as claimed in claim 8, wherein the motion estimator is used to produce a motion vector according to the block matching between the macroblocks and the reference window.

17. An image encoding method, including a forward search and a backward search, suitable for encoding a video image with a plurality of reference frames and a plurality of estimated frames, comprising steps of:
reading one of the reference windows and at least two of the estimated frames; and
executing the forward search to achieve block matching between at least said two of the estimated frames that have been read and said one of the reference frames if one of the reference frames that have been read is located before two of the estimated frames that have been read, otherwise, executing the backward search to achieve the block matching between at least said two of the estimated frames that have been read and said one of the reference frames.

18. The image encoding method as claimed in claim 17, in the step of executing the forward search, the forward search comprising:
reading a reference window from one of the reference frames, wherein a first position is the position of reference window;
reading a plurality of macroblocks from at least two of the estimated frames, wherein a second position is the position of macroblocks, and the second position corresponds to the first position;
executing the block matching between the macroblocks and the reference window; and
changing reading positions of the first position and the second position, and repeating the above steps until the block matching with all the macroblocks in at least two of the estimated frames has been finished.

19. The image encoding method as claimed in claim 17, in the step of executing the backward search, the backward search comprising:
reading a reference windows from one of the reference frames, wherein a first position is the position of reference window;
reading a plurality of macroblocks from at least two of the estimated frames, wherein a second position is the position of macroblocks, and the second position corresponds to the first position;
executing the block matching between the macroblocks and the reference window; and
changing the reading positions of the first position and the second position, and repeating the above steps until the block matching of all the macroblocks in at least two of the estimated frames has been finished.

20. The image encoding method as claimed in claim 18, wherein the reference frames comprise a plurality of I frames and a plurality of P frames.

21. The image encoding method as claimed in claim 18, wherein the reference frames comprise a plurality of P frames.

22. The image encoding method as claimed in claim 18, wherein the estimated frames comprise a plurality of B frames.

23. The image encoding method as claimed in claim 18, wherein the estimated frames comprise a plurality of B frames and a plurality of P frames.

24. The image encoding method as claimed in claim 19, wherein the reference frames comprise a plurality of P frames.

25. The image encoding method as claimed in claim 19, wherein the reference frames comprise a plurality of B frames.
